(19) United States
(12) Patent Application Publication
(10) Pub. No.: US 2024/0093732 A1
(43) Pub. Date: Mar. 21, 2024

(54) LIGHTWEIGHT COMPOSITE BEARING ASSEMBLY

(71) Applicant: AKTIEBOLAGET SKF, Goteborg (SE)

(72) Inventor: Bryan ALLISON, Clymer, NY (US)

(21) Appl. No.: 17/945,554

(22) Filed: Sep. 15, 2022

(51) Int. Cl. F16C 33/62; F16C 33/66

(52) U.S. Cl. CPC F16C 33/62; F16C 33/66

(57) ABSTRACT

A bearing assembly includes an inner ring having an inner raceway and an outer ring disposed about the inner ring and having an outer raceway. A plurality of rolling elements, preferably balls, are disposed between the inner ring and the outer ring such that each one of the rolling elements rolls simultaneously upon the inner raceway and the outer raceway. The inner ring and/or the outer ring is formed of a lightweight composite material, the composite material including a mixture of a base polymer, reinforcing fibers and a lubricant, preferably polyoxymethylene, glass fibers and silicone. Further, each one of the inner raceway and the outer raceway is formed such that each ball contacts two separate points on the inner raceway and contacts two separate points on the outer raceway such that the bearing assembly is configured to support loading in both directions along a central axis.

### BACKGROUND OF THE INVENTION

The present invention relates to bearings, and more particularly to rolling element bearings.

Rolling element bearings are well known and basically include an inner ring, an outer ring disposed about the inner ring and a plurality of rolling elements disposed between the inner and outer rings. In certain applications in which a particularly “clean” environment is required, for example, food and beverage processing equipment, semiconductor manufacturing, etc., the bearing rings are formed of a polymeric material. Such bearings require no lubricating grease, resist corrosion and are low cost. However, bearings with polymeric rings have lower stiffness and strength in comparison with typical bearings with metallic rings, which reduces the load carrying capacity of such bearings.

### SUMMARY OF THE INVENTION

In one aspect, the present invention is a bearing assembly comprising an inner ring having an inner raceway and an outer ring disposed about the inner ring and having an outer raceway. A plurality of rolling elements are disposed between the inner ring and the outer ring such that each one of the rolling elements rolls simultaneously upon the inner raceway and the outer raceway. The inner ring and/or the outer ring is formed of a lightweight composite material, the composite material including a mixture of a base polymer, reinforcing fibers and a lubricant.

In another aspect, the present invention is again a bearing assembly as described in the preceding paragraph and further in which the bearing assembly rotatably couples an inner member and an outer member, one of the inner and outer members being rotatable about a central axis. The inner ring is disposeable about the inner member and the outer ring is coupleable with the outer member. Each one of the inner raceway and the outer raceway is formed such that each ball contacts two separate points on the inner raceway and contacts two separate points on the outer raceway such that the bearing assembly is configured to support loading in both directions along the central axis.

In a further aspect, the present invention is again a bearing assembly as described in Paragraph above and further in which the bearing assembly rotatably couples an inner member and an outer member, one of the inner and outer members being rotatable about a central axis. The inner ring is disposeable about the inner member and the outer ring is coupleable with the outer member. Further, the lightweight composite material preferably includes a mixture of polyoxymethylene, glass fibers and silicone.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, axial cross-sectional view of a bearing assembly of the present invention, shown installed about an inner member and within an outer member;

FIG. 2 is an enlarged, broken-away view of a portion of the bearing inner ring, shown with a greatly enlarged view of section of the bearing depicting the material composition of the ring;

FIG. 3 is a broken-away, cross-sectional view of an upper portion of the bearing assembly, depicting four points of contact of each rolling element; and

FIG. 4 is another is a broken-away, cross-sectional view of an upper portion of the bearing assembly, depicting a preferred raceway structure providing the four points of contact.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

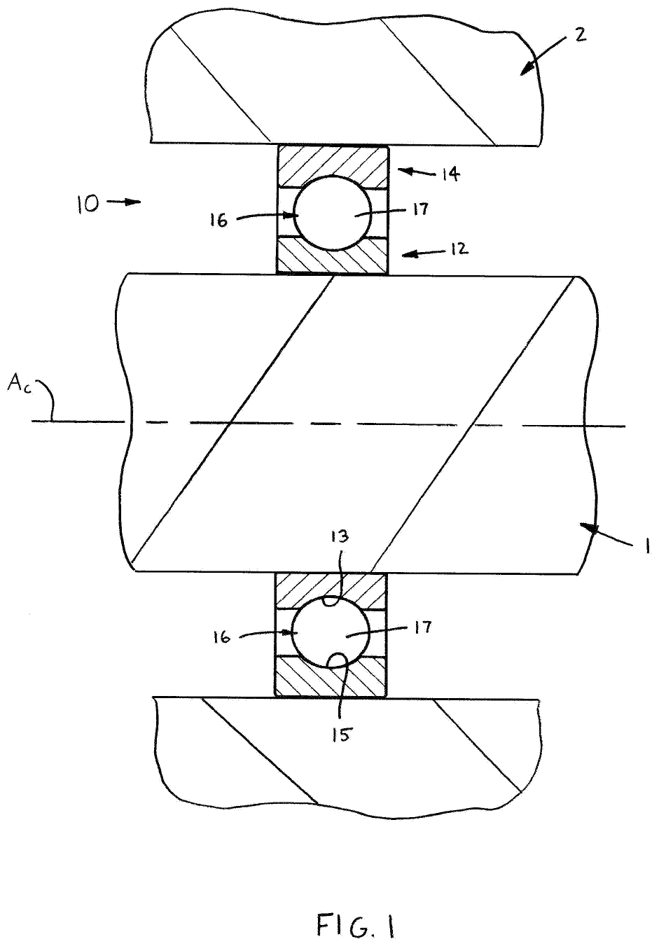

Referring now to the drawings in detail, wherein like numbers are used to indicate like elements throughout, there is shown in FIGS. 1-4 a bearing assembly 10 for rotatably coupling an inner member 1 and an outer member 2, at least one of the two members 1, 2 being rotatable about a central axis A_{C} extending through the inner member 1. The bearing assembly 10 basically comprises an inner ring 12, an outer ring 14 and a plurality of rolling elements 16, at least one of the rings 12, 14 being formed of a lightweight composite material M as described below.

More specifically, the inner ring 12 has an inner raceway 13 and the outer ring 14 is disposed about the inner ring 12 and has an outer raceway 15. The plurality of rolling elements 16 are disposed between the inner ring 12 and the outer ring 14 such that each one of the rolling elements 16 rolls simultaneously upon the inner raceway 13 and the outer raceway 15. Preferably, each one of the rolling elements 16 is a ball 17 for reasons described below, but may be any other appropriate type of rolling element, such as for example, a cylindrical roller, a tapered roller, a needle, etc.

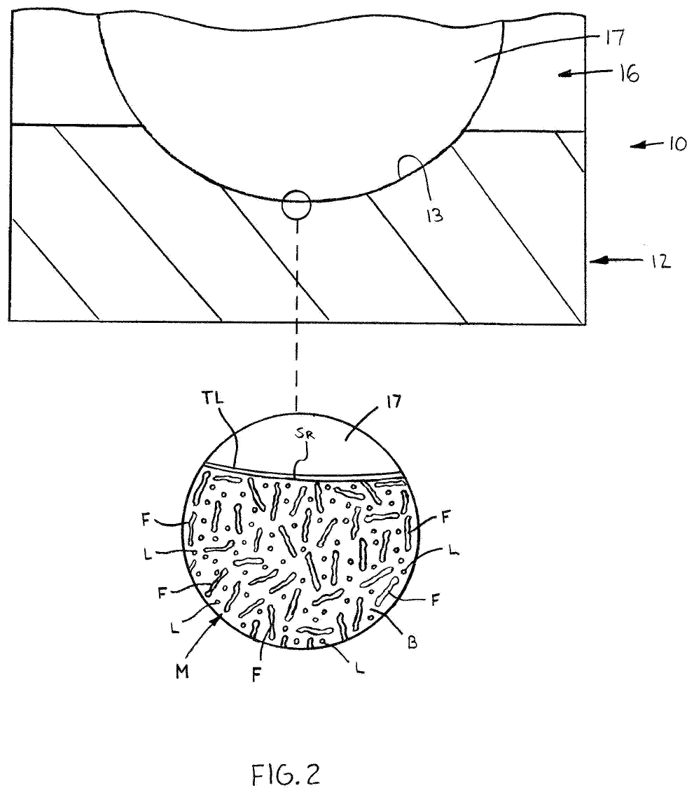

At least one, and preferably both, of the inner and outer rings 12, 14 is formed of the lightweight composite material M, which includes a mixture of a base polymer B, reinforcing fibers F and a lubricant L, as depicted in FIG. 2. The reinforcing fibers F increase the strength and rigidity of the ring 12 and/or ring 14 formed of the composite material M and the lubricant L within the material M is intended to provided “self” lubrication for the bearing assembly 10. More specifically, the particles of lubricant L within the composite material M are configured to form a tribolayer TL between the rolling elements 16 and the glass fibers F of the composite material M during use of the bearing assembly 10. That is, due to compression and shearing caused by traversal of the rolling elements 16 on the raceways 13, 15, a certain portion of the particles of lubricant L separate from a remainder of the material M to form the layer TL on the outer surface SR of the raceways 13, 15. This lubrication layer TL not only provides the typical function of a bearing lubricant, i.e., to reduce friction between the rolling elements 16 and the raceways 13, 15, but also prevents direct contact with, and thereby erosion of, the reinforcing fibers F.

Preferably, the base polymer B is polyoxymethylene, but may alternatively be polyamide, polybutylene terephthalate, polyether ether ketone, or any similar polymer. The reinforcing fibers F preferably include at least one of glass fibers, carbon fibers, aramid fibers and glass beads, and are most preferably entirely glass fibers. Further, the lubricant L is preferably silicone, but may alternatively be polytetrafluoroethylene, molybdenum disulfide, or any similar lubricant. Furthermore, each rolling element 16 is preferably formed of steel, but may be formed of glass, ceramic, etc. and/or may include any desired combination rolling elements 16 formed of different appropriate materials.

Preferably, the composite material M is formed such that the amount of the glass fibers F in the composite material M is between about ten percent (10%) by weight and about fifty percent (50%) by weight and the amount of the lubricant in the composite material is between about one percent (1.0%) by weight and about ten percent (10%) by weight. Most preferably, the amount of the glass fibers F in the composite material M is between about twenty percent (20%) by weight and about twenty-five percent (25%) by weight and the amount of the lubricant L in the composite material M is between about two percent (2.0%) by weight and about five percent (5.0%) by weight. With the desired material composition, each bearing ring 12, 14 has a stiffness of at least four Gigapascals (4 GPa) and/or a coefficient of thermal expansion of less than sixty micrometers per meter per degrees Celsius (60 μm/m/° C.). However, the actual percentages of glass fibers F and lubricant L within the composite material M may be within any other desired, appropriate ranges and thereby may have different stiffnesses and/or coefficients of thermal expansion.

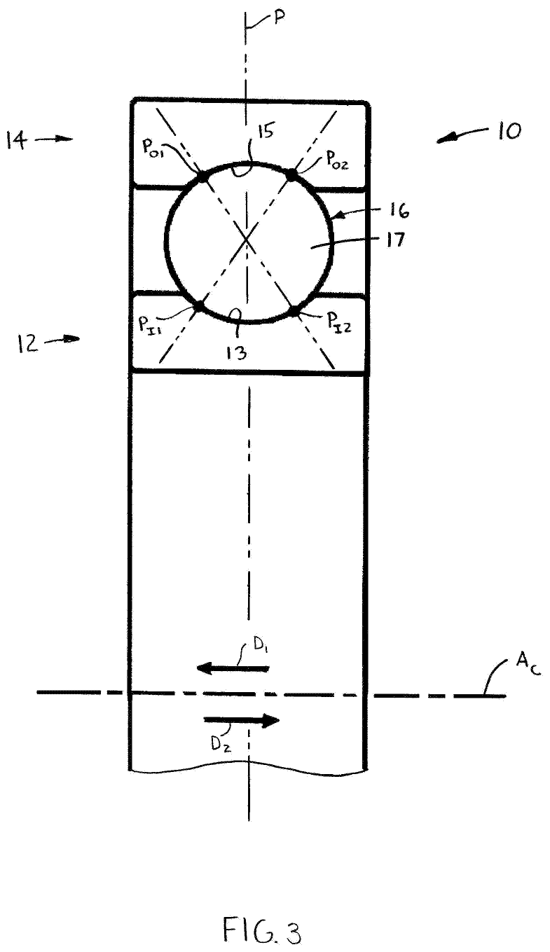

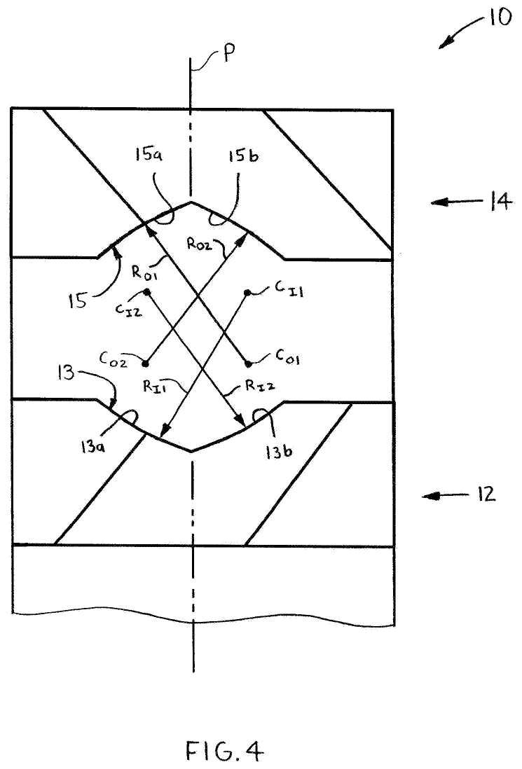

Referring now to FIGS. 3 and 4, the bearing assembly 10 is preferably constructed as a “four point” deep groove ball bearing. Being a deep groove ball bearing, each raceway 13, 14 is at least generally symmetrical about a plane P extending centrally through each bearing ring 12, 14, respectively, and each rolling element 16 is a ball 17. Also, as a four point contact bearing, each raceway 13, 15 is formed such that each rolling element 16 contacts each raceway 13, 15 at two separate points. Specifically, the inner raceway 13 is formed such that each ball 17 contacts two separate points P₁₁, P₁₂ on the inner raceway 13 and the outer raceway 15 is formed such that each ball 17 contacts two separate points P_{O1}, P_{O2} on the outer raceway 15, as indicated in FIG. 3. With this structure, the bearing assembly 10 is configured to support bidirectional axial loading, i.e., loading in either direction D₁ or D₂ along the central axis A_{C}, as well as typical radial loading.

Most preferably, each raceway 13, 15 is formed as a “gothic arch” having two converging surface sections, each surface section having a separate radius about a center spaced apart from the center of the radius of the other section, as depicted in FIG. 4. Specifically, the inner raceway 13 has a first surface section 13a with a radius R₁₁ about a first center C₁₁ and a second surface section 13b with a radius R₁₂ about a second center C₁₂ spaced from the first center C₁₂, the two surface sections 13a, 13b converging at the central plane P (FIG. 4). Similarly, the outer raceway 15 has a first surface section 15a with a radius R_{O1} about a first center C_{O1} and a second surface section 15b with a radius R_{O2} about a second center C_{O2} spaced from the first center C_{O2}, the two surface sections 15a, 15b converging at the central plane P. However, the raceways 13, 15 may be formed in any other appropriate manner which provides two points of contact on each raceway 13, 15, such as for example, with two surface sections providing contact points connected by a central surface section with a different radius of curvature (structure not shown).

The bearing assembly 10 of the present invention with the inner ring 12 and/or the outer ring 14 formed of composite material M is both lightweight and has a substantially greater strength than known polymeric bearings. As such, the load carrying capacity of the present bearing assembly 10 is substantially greater than such known polymeric bearings while remaining suitable for use in “clean” environments (e.g., food processing, microchip manufacturing, etc.). Further, the preferred raceway structure providing four-point ball contact enables the bearing assembly 10 to support axial loading in both directions as well as radial loading.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A bearing assembly comprising:
an inner ring having an inner raceway, an outer ring disposed about the inner ring and having an outer raceway and a plurality of rolling elements disposed between the inner ring and the outer ring such that each one of the rolling elements rolls simultaneously upon the inner raceway and the outer raceway;
wherein at least one of the inner ring and the outer ring is formed of a lightweight composite material, the composite material including a mixture of a base polymer, reinforcing fibers and a lubricant.

2. The bearing assembly as recited in claim 1 wherein each one of the inner ring and the outer ring is formed of the composite material.

3. The bearing assembly as recited in claim 1 wherein the lubricant within the composite layer is configured to form a tribolayer between the rolling elements and the glass fibers of the composite material during use of the bearing assembly.

4. The bearing assembly as recited in claim 1 wherein the base polymer is one of polyoxymethylene, polyamide, polybutylene terephthalate, and polyether ether ketone.

5. The bearing assembly as recited in claim 1 wherein the reinforcing fibers include at least one of glass fibers, carbon fibers, aramid fibers and glass beads.

6. The bearing assembly as recited in claim 1 wherein the lubricant includes at least one of silicone, polytetrafluoroethylene and molybdenum disulfide.

7. The bearing assembly as recited in claim 1 wherein the base polymer is polyoxymethylene, the reinforcing fibers are glass fibers, and the lubricant is silicone.

8. The bearing assembly as recited in claim 1 wherein each rolling element is formed of steel, glass or ceramic.

9. The bearing assembly as recited in claim 1 wherein each rolling element is a ball and each one of the inner raceway and the outer raceway is formed such that each ball contacts two separate points on the inner raceway and contacts two separate points on the outer raceway such that the bearing assembly is configured to support bidirectional axial loading.

10. The bearing assembly as recited in claim 1 wherein:
an amount of the glass fibers in the composite material is between about ten percent (10%) by weight and about fifty percent (50%) by weight; and
an amount of the lubricant in the composite material is between about one percent (1.0%) by weight and about ten percent (10%) by weight.

11. The bearing assembly as recited in claim 1 wherein:
an amount of the glass fibers in the composite material is between about twenty percent (20%) by weight and about twenty-five percent (25%) by weight; and
an amount of the lubricant in the composite material is between about two percent (2.0%) by weight and about five percent (5.0%) by weight.

12. The bearing assembly as recited in claim 1, wherein the at least one of the inner ring and the outer ring formed of the composite material has a stiffness of at least four Gigapascals (4 GPa) and/or a coefficient of thermal expansion of less than sixty micrometers per meter per degrees Celsius (60 μm/m/° C.).

13. A bearing assembly for rotatably coupling an inner member and an outer member, one of the inner and outer members being rotatable about a central axis, the bearing assembly comprising:
an inner ring disposeable about the inner member and having an inner raceway;
an outer ring disposed about the inner ring, coupleable with the outer member and having an outer raceway; and
a plurality of balls disposed between the inner ring and the outer ring such that each ball rolls simultaneously upon the inner raceway and the outer raceway;
wherein at least one of the inner ring and the outer ring is formed of a lightweight composite material, the composite material including a mixture of a base polymer, reinforcing fibers and a lubricant; and
wherein each one of the inner raceway and the outer raceway is formed such that each ball contacts two separate points on the inner raceway and contacts two separate points on the outer raceway such that the bearing assembly is configured to support loading in both directions along the central axis.

14. The bearing assembly as recited in claim 13 wherein each one of the inner ring and the outer ring is formed of the composite material.

15. The bearing assembly as recited in claim 13 wherein the lubricant within the composite layer is configured to form a tribolayer between the balls and the glass fibers of the composite material during use of the bearing assembly.

16. The bearing assembly as recited in claim 13 wherein:
the base polymer is one of polyoxymethylene, polyamide, polybutylene terephthalate, and polyether ether ketone;
the reinforcing fibers include at least one of glass fibers, carbon fibers, aramid fibers and glass beads; and
the lubricant includes at least one of silicone, polytetrafluoroethylene and molybdenum disulfide.

17. The bearing assembly as recited in claim 13 wherein:
an amount of the glass fibers in the composite material is between about ten percent (10%) by weight and about fifty percent (50%) by weight; and
an amount of the lubricant in the composite material is between about one percent (1.0%) by weight and about ten percent (10%) by weight.

18. A bearing assembly for rotatably coupling an inner member and an outer member, one of the inner and outer members being rotatable about a central axis, the bearing assembly comprising:
an inner ring disposeable about the inner member and having an inner raceway;
an outer ring disposed about the inner ring, coupleable with the outer member and having an outer raceway; and
a plurality of balls disposed between the inner ring and the outer ring such that each ball rolls simultaneously upon the inner raceway and the outer raceway;
wherein each one of the inner ring and the outer ring is formed of a lightweight composite material, the composite material including a mixture of polyoxymethylene, glass fibers and silicone.

19. The bearing assembly as recited in claim 18 wherein the lubricant within the composite layer is configured to form a tribolayer between the balls and the glass fibers of the composite material during use of the bearing assembly.

20. The bearing assembly as recited in claim 18 wherein at least one of:
an amount of the glass fibers in the composite material is between about twenty percent (20%) by weight and about twenty-five percent (25%) by weight and an amount of the lubricant in the composite material is between about two percent (2.0%) by weight and about five percent (5.0%) by weight;
each one of the inner raceway and the outer raceway is formed such that each ball contacts two separate points on the inner raceway and contacts two separate points on the outer raceway such that the bearing assembly is configured to support axial loading in both directions along the central axis; and
each one of the inner ring and the outer ring formed of the composite material has a stiffness of at least four Gigapascals (4 GPa) and/or a coefficient of thermal expansion of less than sixty micrometers per meter per degrees Celsius (60 μm/m/° C.).
